(19) United States
(12) Patent Application Publication
(10) Pub. No.: US 2023/0072906 A1
(43) Pub. Date: Mar. 9, 2023

(54) COCOA COMPOSITION

(71) Applicant: CARGILL, INCORPORATED, Wayzata, MN (US)

(72) Inventors: Vanessa BAREY, Mouscron (BE); Stefan VERVLIET, Mouscron (BE)

(73) Assignee: CARGILL, INCORPORATED, Wayzata, MN (US)

(21) Appl. No.: 17/904,319

(22) PCT Filed: Feb. 18, 2021
(86) PCT No.: PCT/US2021/018482

§ 371 Date: Aug. 16, 2022

(30) Foreign Application Priority Data
Feb. 21, 2020 (EP) 20158685.6

(51) Int. Cl. A23G 1/44; A23G 1/36; A23G 1/40; A23G 1/48

(52) U.S. Cl. CPC A23G 1/44; A23G 1/36; A23G 1/40; A23G 1/48

(57) ABSTRACT

The present invention relates to a cocoa composition comprising at least 30 weight % sucrose and less than 5 weight % of milk solids, characterized in that it comprises 0.5-15 weight % of a plant-based protein other than soy protein, and 0.5-20 weight % of a bulking ingredient. Food products comprising the cocoa composition described are also provided, for example, bakery products, confectionary products, and dairy-alternative products.

### CROSS-REFERENCE TO RELATED APPLICATIONS

This application claims the benefit of European Patent Application No. 20158685.6, filed Feb. 21, 2020, which is hereby incorporated by reference herein in its entirety.

### FIELD OF THE INVENTION

The invention relates to a cocoa composition that is low in milk solids, comprising a plant-based protein and a bulking ingredient, said cocoa composition having a sensorial quality comparable to that of milk-containing cocoa compositions. The invention further relates to food products comprising the cocoa composition according to the invention.

### BACKGROUND OF THE INVENTION

Chocolate flavour is one of the most popular flavors in the world, with many foodstuffs incorporating chocolate or cocoa-derived ingredients in some fashion. Chocolate confectionary covers a wide range of sweet food products based on cocoa-derived ingredients, such as chocolate, cocoa-based coatings or couvertures, and cocoa-based fillings. Chocolate is especially popular for its typical fast melting in the mouth resulting in an explosion of bitter-sweet cocoa taste. Many chocolate confectionary recipes also contain in addition to the cocoa-derived ingredients milk solids to give an extra dimension of creaminess and milky taste.

However, despite its appeal, milk-based chocolate confectionary products contain significant amounts of butter fat, milk protein and lactose. As a result, milk-based chocolate confectionary cannot be consumed by those suffering from lactose intolerance or milk allergies. It will also be undesirable for those following a vegan diet or avoiding dairy for religious or lifestyle reasons.

Past attempts to replace milk solids in milk-based chocolate confectionary products have resulted in a products of poor sensorial quality that lack the typical creamy mouthfeel and flavor of traditional milk-based chocolate confectionary products.

Thus, there remains a need for chocolate confectionary products reduced in milk solids with an improved quality and eating sensation.

### SUMMARY OF THE INVENTION

The present invention relates to a cocoa composition comprising at least 30% weight % sucrose, less than 5 weight % milk solids, and characterized in that it comprises 0.5-15 weight % plant-based protein other than soy protein, and 0.5-20 weight % bulking ingredient. The present invention also relates to a food product comprising such a cocoa composition, characterized in that the food product is, for example, a bakery or confectionary product.

### DETAILED DESCRIPTION

Unless otherwise specified herein, all weights are expressed as a percentage, by weight, relative to the total weight of the cocoa composition.

The present invention relates to a cocoa composition comprising at least 30% weight % sucrose, less than 5 weight % milk solids, and characterized in that it comprises 0.5-15 weight % plant-based protein other than soy protein, and 0.5-20 weight % bulking ingredient.

### Cocoa Composition

The term “cocoa composition” will be used to refer to a substantially homogeneous and fat-continuous composition, typically comprising a mixture of cocoa liquor and/or cocoa powder, cocoa butter and/or cocoa butter replacers, equivalents, improvers, and/or substitutes, sugar and/or sugar replacers plus one or more optional ingredients such as emulsifiers and flavoring agents.

The cocoa composition according to the present invention comprises cocoa solids in an amount of at least 2 weight %, preferably at least 3 weight %, more preferably at least 5 weight %, more preferably at least 10 weight %, more preferably at least 15 weight %.

The term “cocoa solids” as used herein may refer to any component derived from cocoa beans such as, but not limited to, cocoa liquor, cocoa powder and/or cocoa butter.

Cocoa liquor, also called “cocoa mass”, is produced from ground cocoa beans. Prior to or after grinding, the beans may be fermented, dried, roasted, alkalized and/or treated using any other technique known in the art. In one aspect, the cocoa composition of the present invention will comprise 5-30 weight %, preferably 10-25 weight %, more preferably 15-25 weight %, more preferably 18-22 weight % cocoa liquor.

Cocoa butter is the fat extracted from cocoa beans, typically by pressing the cocoa liquor. Cocoa butter may be deodorized to remove strong or undesirable tastes. Cocoa butter may be replaced, in whole or in part, by cocoa butter alternatives. Cocoa butter alternatives are well known in the art and include cocoa butter replacers, cocoa butter equivalents, cocoa butter improvers, and cocoa butter substitutes. They are typically vegetable fats and/or vegetable fat fractions with similar physical or chemical properties to cocoa butter.

Cocoa powder is produced by further grinding or milling the “dry” residue obtained from cocoa liquor after pressing. It may be natural cocoa powder, with a pH of around 5.5, or it may be processed (e.g. treated with alkali or acid). It may have a relatively high fat content, e.g. above 15 weight % residual cocoa butter, a standard fat content (e.g. 10-15 weight % cocoa butter), or a low fat content (less than 10 weight % cocoa butter). Fat-free cocoa powders may also be used (e.g. with a fat content of less than 2 weight %).

In one aspect of the invention, the cocoa composition is a chocolate composition and is characterized in that it comprises cocoa solids in an amount of at least 30 weight %, preferably at least 33 weight %, more preferably at least 35 weight %. In one preferred aspect, the composition of the invention will comprise 30-95 weight %, preferably 30-75 weight %, more preferably 30-55 weight % of cocoa solids. Advantageously, the composition will include not less than 18 weight %, preferably not less than 20 weight %, more preferably not less than 25 weight % cocoa butter.

The terms “chocolate composition” and “chocolate” will be used interchangeably. Although, they should not be interpreted as being limited to any particular legal definitions of chocolate, in one aspect of the invention, the chocolate composition will be a chocolate product as defined in Directive 2000/36/EC of the European Parliament and of the Council of 23 Jun. 2000.

Alternatively, the cocoa composition according to the present invention may comprise cocoa solids in an amount of from 2 to 20 weight %, preferably of from 3 to 18 weight %, more preferably of from 3 to 15 weight %. Examples of such cocoa compositions include coating (or couverture) and compound type compositions. These compositions can typically be differentiated from chocolate compositions in that at least some of the cocoa butter content has been replaced by one or more cocoa butter alternatives.

The cocoa composition according to the present invention comprises milk solids in an amount of less than 5 weight %, preferably in an amount of less than 4 weight %, more preferably less than 3 weight %, more preferably less than 2 weight %, more preferably less than 1 weight %. Milk solids according to the present invention may be defined as any dry component derived from milk such as, but not limited to, milk fat or fractions thereof, lactose, skimmed or whole milk powder, whey, whey powder, caseinate, and/or milk hydrolysate. As used herein, “milk” refers to milks of mammalian origin (e.g. non-human milks such as cow, buffalo, sheep, and/or goat milk). In one aspect, the cocoa composition of the invention will be substantially free of milk solids.

Although they may be used to produce foodstuffs comprising coatings, fillings or inclusions, the cocoa compositions of the invention will not themselves include such components. Indeed, the compositions of the invention will preferably be homogenous (or “continuous”) cocoa compositions, i.e. with a consistent texture and structure throughout.

The cocoa compositions will preferably be moldable compositions. As used herein, the term “moldable” refers to a composition that is capable of being formed into a shape in a mold, setting (preferably at room temperature), and then retaining the molded shape after removal of the mold. Thus, the compositions of the invention will preferably not be in the form of a powder or of a particulate material. Furthermore, the compositions of the present invention will preferably have a water content of less 10% by weight based on the total weight of the composition. More preferably, they will have a water content of less 5%, more preferably less than 3%, more preferably less than 2%, and more preferably less than 1% by weight.

### Plant-Based Protein

The chocolate composition according to the invention comprises 0.5-15 weight %, preferably 1-10 weight %, more preferably 2-5 weight % plant-based protein, provided however that the plant-based protein does not comprise soy protein.

The term “plant-based protein” as used herein refers to proteins originating from any plant source except for soy. It will also be understood not to include any protein content incidentally present in the cocoa solids—in other words, the plant-based protein of the invention is a non-cocoa plant-based protein.

The plant-based protein may be added to the chocolate composition of the invention in the form of a powder or paste of a whole plant, or of a specific plant part (such as the seed or the fruit), or as a protein concentrate or isolate from the plant. Preferably, the plant-based protein will be from a source which is rich in protein (i.e. having a protein content of at least 10 weight %). Examples of suitable plant sources include, but are not limited to, legumes, cereals, grains, nuts and combinations of two or more thereof.

“Legumes” are plants from the family of Fabaceae, also called Leguminosae. Legumes suitable for use according to the present invention include but are not limited to alfalfa, clover, beans (including for example fava beans), peas, chickpeas, lentils, lupins, mesquite, carob, soybeans, peanuts, and tamarind.

“Cereals and grains” are plants of the family of Poaceae and include amongst others maize, oat, wheat, rice, barley, and millet. According to the present invention, suitable “cereals and grains” may also include pseudo-cereals such as buckwheat (Polygonaceae), quinoa (Amaranthaceae) and chia (Lamiaceae).

Suitable “nuts” may include, amongst others, hazelnuts (Corylus), chestnuts (Castanea), almonds (Prunus dulcis), pecans (Carya illinoinensis), pistachios (Pistacia vera), walnuts (Juglans) and Brazil nuts (Bertholletia excelsa).

In one preferred aspect of the invention the plant-based protein in the chocolate composition is pea protein. Pea protein may be present in the chocolate composition in the form of pea protein isolate, pea protein concentrate, whole pea powder, extruded micronized pea powder, hydrolyzed pea protein or the like. It may also be roasted (e.g. in the form of roasted pea powder) prior to use. Concentrates and pea protein isolates are defined in terms of their protein content. “Pea protein concentrates” have a total protein content of 60 to 75% on a dry weight basis, while “pea protein isolates” have a total protein content of 90 to 95% on a dry weight basis. “Pea protein hydrolysates” are preparations obtained by enzymatic and/or chemical hydrolysis of pea protein. Protein hydrolysates consist of a mixture of peptides of different sizes and free amino acids.

### Bulking Ingredient

The cocoa composition of the invention comprises 0.5-20.0 weight % of a bulking ingredient. Preferably, the bulking ingredient will be present in the chocolate composition in an amount from 1.0 to 19.0 weight %, more preferably from 2.0 to 18.0 weight %, more preferably from 3.0 to 16.0 weight %, more preferably from 4.0 to 14.0 weight %.

The bulking ingredient may be selected from the group consisting of oligosaccharides, polysaccharides, soluble dietary fibres, insoluble dietary fibres and mixtures of two or more thereof.

Oligosaccharides are saccharide polymers containing a small number, typically three to ten, of monosaccharides. Suitable oligosaccharides for use in the present invention include fructo-oligosaccharides (FOS). FOS are short chains of fructose molecules found in many vegetables. They are considered soluble dietary fibres. Another type of suitable oligosaccharides is galacto-oligosaccharides (GOS), which also occur naturally. They consist of short chains of galactose molecules. These compounds, which act as soluble fibres, cannot be digested in the human small intestine, and instead pass through to the large intestine, where they promote the growth of Bifidobacteria, which are beneficial to gut health.

In one aspect of the invention the bulking ingredient comprises an oligosaccharide in a range of from 2.0 to 15.0 weight %, preferably in a range of from 3.0 to 12.0 weight %, more preferably in a range of from 4.0 to 10.0 weight %.

Suitable polysaccharides include glucose polymers such as starch, and starch-derivatives such as glucose syrup, maltodextrin and dextrin. Fructans and inulin are further examples of suitable polysaccharides. These are polymers of fructose with a much higher degree of polymerization than FOS. They are also considered soluble dietary fibres. Another example of soluble fibre suitable for use in the present invention is polydextrose which is obtained by thermal polymerisation of dextrose. Suitable polysaccharides may also include agar, galactomannans such as guar gum, locust bean gum, and amylopectins, pectin and combinations of two or more of the above.

In one aspect of the invention the bulking ingredient comprises a polysaccharide in a range of from 2.0 to 15.0 weight %, preferably in a range of from 3.0 to 12.0 weight %, more preferably in a range of from 4.0 to 10.0 weight %.

Suitable insoluble fibres may be selected from the group consisting of resistant starches, cereal fibres, fruit fibres, fibres of legumes and mixtures of two or more thereof.

Preferably, the bulking ingredient will be selected from the group consisting of vegetable fibres, dextrin, maltodextrin, polydextrose, inulin, dehydrated grain syrups (such as dried rice syrup), pectin, and mixtures of two or more thereof.

Alternatively, the bulking agent will include or consist of vegetable fibres selected from the group consisting of cereal and grain fibres, fruit fibres and mixtures of two or more thereof, preferably rice fibres, pea fibres, coconut fibres, soy fibres and mixtures of two or more thereof.

In yet another aspect of the invention, the bulking ingredient comprises 3.0-15.0 weight % of an oligo- and/or polysaccharide and 0.5-10.0 weight % of a vegetable dietary fibre. More preferably the bulking ingredient comprises 3.5-10.0 weight % of a polysaccharide and 1.0-6.0 weight % of a vegetable fibre.

### Sweeteners

The cocoa composition of the invention comprises at least 30 weight % sucrose. The amount of sucrose in the cocoa composition will preferably be at least 30.5 weight %, more preferably at least 32 weight %, more preferably at least 35 weight %.

Preferably, the cocoa composition will not include maltitol, lactitol, and/or erythritol in an amount of more than 30 weight %, more preferably not in an amount of more than 20 weight %, more preferably not in an amount of more than 10 weight %, more preferably not in an amount of more than 5 weight %. Advantageously, it will contain substantially no maltitol, lactitol, and/or erythritol. In one aspect, it will not include any sugar alcohols. In another aspect, the composition will not include any high intensity sweeteners. In another aspect, it will not include any non- or low-caloric sweeteners.

In one aspect of the invention the cocoa composition is a chocolate composition, comprising at least 30 weight % of sucrose, at least 30 weight % of cocoa solids and less than 2 weight % of milk solids, characterized in that it comprises 0.5-15 weight % plant protein (other than soy) and 0.5-20.0 weight % of a bulking ingredient.

In a more preferred aspect of the invention, the cocoa composition is a chocolate composition, comprising at least 30 weight % of sucrose, at least 30 weight % of cocoa solids and less than 2 weight % of milk solids, characterized in that it comprises 0.5-15 weight % plant protein (other than soy) and 0.5-20.0 weight % of a bulking ingredient, wherein the bulking ingredient is selected from the group consisting of an oligosaccharide, a polysaccharide, a soluble dietary fiber, an insoluble dietary fiber and a mixture of two or more thereof and wherein the composition is free of carob, soy and/or sugar alcohols.

Alternatively, the cocoa composition of the invention will comprise at least 30 weight % of sucrose, 2-20 weight % of cocoa solids and less than 2 weight % of milk solids, characterized in that it comprises 0.5-15 weight % plant protein (other than soy) and 0.5-20.0 weight % of a bulking ingredient.

In a more preferred aspect of the invention, the cocoa composition comprises at least 30 weight % of sucrose, 2-20 weight % of cocoa solids and less than 2 weight % of milk solids, characterized in that it comprises 0.5-15 weight % plant protein (other than soy) and 0.5-20.0 weight % of a bulking ingredient wherein the bulking ingredient is selected from the group consisting of an oligosaccharide, a polysaccharide, a soluble dietary fiber, an insoluble dietary fiber and a mixture of two or more thereof and wherein the composition is free of carob, soy and/or sugar alcohols.

Advantageously, the cocoa composition according to the invention shows very similar properties to milk-containing cocoa compositions. Along with the cocoa-derived ingredients, milk solids are responsible for some of the most important properties of cocoa compositions. These properties include its sensory qualities, its creamy mouth feel and snap, for instance, and its melting behavior. It was found that the cocoa composition according to the invention, although not brittle, maintains the desired snappy effect when broken or bitten into. It was found to have a creamy eating sensation that is comparable to that of milk-based cocoa compositions.

The cocoa composition of the present invention can be produced by any conventional method for making chocolate or cocoa-based confectionary compositions known to the skilled person. The cocoa solids and other ingredients of the cocoa composition according to the invention are mixed, ground and conched substantially in the same manner one would produce chocolate or cocoa-based confectionary compositions, using any methods known to those of skill in the art. Once the cocoa composition is processed, it can be placed in molds, or otherwise formed or applied in and/or onto food products as is known in the art.

The cocoa compositions of the present invention may also comprise other ingredients such as emulsifiers and/or flavourings. Emulsifiers suitable for use in the present invention will be well known to a person skilled in the art and may include, by way of example only, lecithin, PGPR and/or variants thereof such as hydrolysed or PC-enriched (or phosphatidylcholine-enriched) lecithin. Flavourings may include, but are not limited to, vanilla flavour, vanillin, caramel flavour and the like. In one aspect of the invention, the cocoa compositions will be free of carob. In one aspect of the invention, the composition will not comprise any plasticizing ingredients. A plasticizing ingredient is an ingredient added for the sole purpose of increasing the plasticity of the composition.

### Food Products

As such, the present invention further relates to food products comprising cocoa compositions as described herein. These food products will preferably be bakery products and/or confectionary products but could also include other dairy-free or dairy-reduced food products (termed “dairy alternative” products).

A “bakery product” can be defined as any food product wherein flour is used to produce a dough or a batter. Examples of bakery products are, without limitation, breads such as bagels, buns, rolls, biscuits and loaf breads; cookies; brownies; muffins; desserts such as cakes, cheesecakes and pies; snack cakes; sweet goods such as doughnuts, Danish, sweet rolls, cinnamon rolls and coffee cake.

A “confectionary product” is a food item that is rich in sugar. Confectionary products may be amongst others candies, candied nuts, candy bars, caramels, chocolates, chocolate bars, chocolate drops, chocolate in the form of hollow figures or any desired shape, filled chocolate bars, pralines, truffles, cereal bars, chewing gum, pastillage, and other confections that are made primarily of sugar.

A “dairy-alternative” product is an alternative for products traditionally based on milk such as but not limited non-dairy beverages; frozen desserts like ice cream; and other chilled desserts; non-dairy alternatives for cultured dairy such as yoghurt, cream and fresh or cream cheeses; and dairy alternatives for custard-based desserts.

Cocoa compositions of the invention may be used in food products in any form such as melted and mixed into the recipe of the end product, in the form of fillings, inclusions, toppings or coatings, molded around other discrete ingredients such as nuts, fruit, dried fruit, biscuits or biscuit pieces, candy pieces or shapes, and the like, or any combination of two or more thereof. Thus, the present invention also relates to bakery products, confectionery products, and frozen or chilled desserts comprising the chocolate compositions of the present invention as a filling, inclusion, topping and/or coating, and to confectionery products comprising the chocolate compositions of the present invention together with one or more discrete ingredients.

### EXAMPLES

A number of samples (1-14) were prepared using the recipes shown in Table 1, below. The ingredients used are described in Table 2.

The dry ingredients (including any bulking agents and vegetable protein ingredients), the cocoa liquor and a part of the cocoa butter were mixed together for 10 minutes in a Hobart mixer at a temperature of 45 to 50° C. The cocoa butter addition was adapted on a case-by-case basis to get a correct texture for refining. Optimal fat content in the mixer was 25-26%.

The resulting chocolate paste was then refined in a Bühler three roll refiner, in order to produce refiner flakes having a reduced particle size between 18 and 24 μm.

The refiner flakes were then dry-conched for 6 hours at a temperature of 65° C. in a 5kg batch Bühler Elkolino monoshaft conche running clockwise at a rotor speed of 1000 rpm. Additional cocoa butter was added when needed during the filling of the conche, in order to ensure a proper mechanical shearing and a good flavour development. At the end of the dry conching, any remaining cocoa butter and PGPR was added to the conche. The mixture was then wet-conched for 30 min at 1500 rpm counter-clockwise at a temperature of 45° C. The chocolate mass was then unloaded.

If necessary, viscosity and yield value of the resulting chocolate were adjusted by adding further cocoa butter and/or emulsifiers (resulting in the total amounts indicated in Table 1).

After adjustment of the rheology, the chocolate underwent a hand tempering process and was moulded into bars. Tempering involves the controlled heating and cooling of the mixture to selectively cause the crystallisation of the cocoa butter in the preferred crystalline form V.

Several of the obtained chocolates were then analysed to determine viscosity, yield value and colour using the methods described below. The results are shown in Table 3.

### Analytical Methods

### Particle Size

A small amount of finished chocolate is placed on the measuring surface of a Mitutoyo micrometer (0-25 mm). By pressing, an indication of the size of the largest non-compressible particles can be measured.

### Colour

Color values are expressed as Hunter L, -a and -b values, where the L value represents the “brightness” of the product (black/white scale), the “a” value represents the amount of green/red and the “b” value represents the amount of yellow/blue. The quotient of “a” over “b” represents the redness of the product. The following procedure is used to determine the color value of chocolate.

A small amount of chocolate at 50° C. is poured into an optically neutral petri dish (diameter 55 mm) right to the top. The petri dish is then placed on a calibrated spectrocolorimeter Minolta CM2500D (Illuminant D65, 10° observer, read values in Hunter L -a and b values, software Minolta SPECTRA MAGIC version 1.00). The L, a and b-values of the chocolate sample are then measured and recorded following the manufacturer's instructions.

### Flow Properties

The flow behaviour of the chocolate is measured by the ICA-Method 46—2000-Viscosity of Cocoa and Chocolate Products using a rheometer RM200 (Lamy Rheology Instruments, Champagne au Mont d'Or, France). It is a shear-rate imposed rheometer whereby its speed ranges from 0.3 to 1500 rpm and the torque from 0.05 to 30 mNm. The temperature of the measuring cell is kept at 40° C. A small amount of chocolate is brought into the tube. After pre-shearing the chocolate for 10 min at 5s-1, a stepped flow procedure is applied by increasing and decreasing the shear rate while measuring the shear stress. The Casson model is used to define Casson Yield stress and Casson Viscosity for recipes with a fat content below 38%. For recipes with a fat content higher than 38% a polynomial model is used.

TABLE 1
Recipes

| Ingredients (%)/Sample no. | 1 | 2 | 3 |
|---|---|---|---|
| WAF Cocoa Liquor | 20.45 | 20.23 | |
| Ghana Cocoa Liquor | | | 11.32 |
| WAF Cocoa Butter | 32.79 | 33.12 | 25.99 |
| Sugar | 39.02 | 38.59 | |
| Cane Sugar | | | 45.1 |
| Rice proteins | | | 6 |
| Pea proteins | 2.99 | 2.96 | |
| Maltodextrin | 4.29 | 4.24 | |
| Dried rice syrup | | | 10.93 |
| Vanillin | 0.01 | 0.01 | |
| Vanilla | | | 0.01 |
| Salt | | | 0.05 |
| PGPR | 0.05 | 0.05 | |
| PC enriched lecithin | 0.4 | | |
| Soy lecithin | | 0.79 | 0.6 |
| TOTAL (%) | 100 | 100 | 100 |
| Theoretical fat content (%) | 44.28 | 44.69 | 33.14 |

TABLE 2
Ingredients

| Ingredient Name | Ingredient Detail/Origin | Function |
|---|---|---|
| WAF Cocoa Liquor | Rain Forest Alliance West African cocoa | Cocoa Solids |
| | liquor/Cargill | |
| Ghana Cocoa Liquor | Ghanaian cocoa liquor/Cargill | Cocoa Solids |
| WAF Cocoa Butter | Rain Forest Alliance West African cocoa | Cocoa Solids |
| | butter/Cargill | |
| Sugar | Standard icing sugar | Sweetener |
| Cane Sugar | Semi-refined (brown) crystalline cane sugar | Sweetener |
| Rice proteins | Rice proteins Remypro N80+/Beneo | Protein |
| Pea proteins | Pea protein isolates Pisane ® B9/Cosucra | Protein |
| Maltodextrin | Maltodextrin C Dry ™ MD01915/Cargill | Bulking Agent |
| Dried rice syrup | Dehydrated rice syrup Sipadry-rice | Bulking Agent |
| | 32/Meurens Natural | |
| Vanillin | Vanillin/Prova | Flavor |
| Vanilla | Natural vanilla extract/Prova | Flavor |
| Salt | Standard table salt/Univar | Flavor |
| PGPR | Polyglycerol polyricinoleate Radiamuls Poly | Emulsifier |
| | 2253K/Oleon | |
| PC enriched lecithin | Soya lecithin Emulfluid ™ NGM/Cargill | Emulsifier |
| Soy lecithin | Soya lecithin Epikuron 135 F IP/Cargill | Emulsifier |

TABLE 3
Measurements

| Sample | 1 | 2 |
|---|---|---|
| Viscosity | 0.376 | 0.396 |
| Yield Value | 1.45 | 1.4 |
| L | 38.94 | 38.91 |
| a | 8.93 | 8.98 |
| b | 10.48 | 10.53 |

1. A cocoa composition comprising at least 30 weight % sucrose and less than 5 weight % of milk solids, characterized in that it comprises 0.5-15 weight % of a plant-based protein other than soy protein, and 0.5-20 weight % of a bulking ingredient.

2. The cocoa composition according to claim 1, characterized in that it comprises 2-20 weight % cocoa solids.

3. The cocoa composition according to claim 1, characterized in that it comprises at least 30 weight % cocoa solids.

4. The cocoa composition according to claim 1, characterized in that the plant-based protein is selected from the group consisting of legumes, cereals and grains, nuts, and combinations of two or more thereof.

5. The cocoa composition according to claim 1, characterized in that the plant-based protein is a pea protein.

6. The cocoa composition according to claim 1, characterized in that the plant-based protein is not derived from peanuts and/or sesame seeds.

7. The cocoa composition according to claim 1, characterized in that the bulking ingredient is an oligosaccharide, a polysaccharide, a soluble dietary fiber, an insoluble dietary fiber, or mixtures of two or more thereof.

8. The cocoa composition according to claim 1, characterized in that the bulking ingredient is selected from the group consisting of vegetable fibers, dextrin, maltodextrin, polydextrose, inulin, dehydrated grain syrups, pectin, and mixtures of two or more thereof.

9. The cocoa composition according to claim 8, characterized in that the vegetable fibers are selected from the group consisting of cereal or grain fibres, fruit fibres, and mixtures of two or more thereof.

10. The cocoa composition according to claim 1, characterized in that it is substantially free from milk solids.

11. The cocoa composition according to claim 1, characterized in that it does not contain any sugar alcohols.

12. The cocoa composition according to claim 1, characterized in that it does not contain any hydrogenated fats.

13. Food products comprising the cocoa composition according to claim 1 together with one or more additional ingredients.

14. Food products according to claim 13, characterized in that the food products are selected from the group consisting of bakery products, confectionary products, and dairy-alternative products.

15. The cocoa composition according to claim 8, characterized in that the vegetable fibers are selected from the group consisting of rice fibres, pea fibres, coconut fibres, soy fibres, and mixtures of two or more thereof.
